(19) United States
(12) Patent Application Publication
(10) Pub. No.: US 2012/0292915 A1
(43) Pub. Date: Nov. 22, 2012

(54) DEVICE AND SYSTEM FOR HARVESTING ENERGY

(75) Inventor: Francis C. Moon, Ithaca, NY (US)

(73) Assignee: CORNELL UNIVERSITY, Ithaca, NY (US)

(21) Appl. No.: 13/502,932

(22) PCT Filed: Oct. 22, 2010
(86) PCT No.: PCT/US10/53810

§ 371 Date: Aug. 1, 2012

Related U.S. Application Data
(60) Provisional application No. 61/254,133, filed on Oct. 22, 2009.

(51) Int. Cl. F03D 9/00

(52) U.S. Cl. 290/55

(57) ABSTRACT

An energy harvesting device is described that is configured to generate electricity from a moving fluid. The energy harvesting device comprises, in one embodiment, an oscillator element and an energy converter that converts the vibration of the oscillator element into direct current (DC). The oscillator elements can be in the form of an array in which exposes to the air flow a plurality of the oscillator elements. In one embodiment, an exemplary oscillator element comprises a blunt-body portion and a flexible structure each being configured so that the combination can generate electrical energy in response to low wind velocity (e.g., at or less than about 3 m/s).

### CROSS-REFERENCE TO RELATED APPLICATIONS

This application is a National Stage application under 35 U.S.C. §371 of PCT Application No. PCT/US2010/053810, filed Oct. 22, 2010, entitled “Device and System for Harvesting Energy,” which claims priority to U.S. Application No. 61/254,133, filed 22 Oct. 2009, entitled “System for Converting Wind Energy into Electrical Energy,” which is incorporated herein by reference in its entirety.

### TECHNICAL FIELD

The subject matter of the present disclosure relates to systems for energy conversion and harvesting and particularly to embodiments of a device and system that are configured to convert wind energy to electrical energy using mechanical vibration.

### BACKGROUND

Building integrated power generation (BIPG) is an active area of architectural design. Its goal is to provide energy without significant ecological footprint. Solar and wind energy are two examples of energy sources compatible with the premise of BIPG.

Solar technologies can be characterized as passive solar or active solar depending on the way they capture, convert, and distribute solar energy. Passive solar techniques include orienting a building to the Sun and selecting materials with favorable thermal mass and/or light dispersing properties. Active solar techniques include the use of photovoltaic panels and collectors to harness the energy. Generating power from the wind is often associated with wind turbines, which use rotating turbines to convert wind energy into electrical energy.

Each of these technologies has limited application to BIPG design. Wind turbines are inherently expensive, large, and requires certain operating conditions (e.g., wind speeds) to generate electricity. Solar technology, on the other hand, is beholden to the sunlight, and is thereby effective in many instances in under certain conditions, the existence of which can be limited by geography and more often the time of day (e.g., daylight hours).

There is therefore a need for an alternative energy source, which is renewable, has a small ecological footprint, and is compatible with BIPG design.

### SUMMARY

In one embodiment, an energy harvesting device comprises an oscillator element and an energy converter coupled to the oscillator element and configured to generate electricity in response to movement of the oscillator element. In one example, the difference between a critical wind speed for the oscillator element with a perturbation and a critical wind speed for the oscillator element without a perturbation is less than about 25%.

In another embodiment, a power panel comprises a frame, an array of vibrating elements secured to the frame, and an energy converter responsive to vibration of the vibrating elements. In one example, the difference between a critical wind speed for one or more of the vibrating elements with a perturbation and a critical wind speed for one or more of the vibrating elements without a perturbation is less than about 25%.

In yet another embodiment, a system comprises an energy harvesting device and an energy converter coupled to the energy harvesting device, the energy converter comprising a first converter device that is configured to convert mechanical vibratory motion into electrical energy. The system also comprises an external device coupled to the energy converter, the external device comprising one or more of a storage device and a load. In one example, the energy harvesting device is configured with an oscillator element that vibrates in response to a moving fluid and the difference between a critical wind speed for the oscillator element with a perturbation and a critical wind speed for the oscillator element without a perturbation is less than about 25% without hysteresis in a vibration amplitude-wind velocity relation.

### BRIEF DESCRIPTION OF THE DRAWINGS

So that the manner in which the above recited features of the present disclosure can be understood in detail, a more particular description of the disclosure briefly summarized above, may be had by reference to the figures, some of which are illustrated and described in the accompanying appendix. It is to be noted, however, that the appended documents illustrate only typical embodiments of this disclosure and are therefore not to be considered limiting of its scope, for the disclosure may admit to other equally effective embodiments. Moreover, any drawings are not necessarily to scale, emphasis generally being placed upon illustrating the principles of certain embodiments of disclosure.

Thus, for further understanding of the nature and objects of the disclosure, references can be made to the following detailed description, read in connection with the figures in which:

FIG. 1 is a side view of an exemplary embodiment of an energy harvesting device;

FIG. 2 is a front view of the energy harvesting device of FIG. 1;

FIG. 3 is a front, plan view of another exemplary embodiment of an energy harvesting device;

FIG. 4 is a schematic diagram of an example of an energy converter for use in an energy harvesting device such as the energy harvesting devices of FIGS. 1-3;

FIG. 5 is a diagram showing one implementation of an energy harvesting device such as the energy harvesting devices of FIGS. 1-3;

FIG. 6 is a perspective view of yet another exemplary embodiment of an energy harvesting device;

FIG. 7 is a side, plan view of an example of an oscillator element for use in an energy harvesting device such as the energy harvesting devices of FIGS. 1-3 and 6;

FIG. 8 is a perspective view of an example of a blunt-body portion for use in an energy harvesting device such as the energy harvesting devices of FIGS. 1-3 and 6;

FIG. 9 is a perspective view of another example of a blunt body portion for use in an energy harvesting device such as the energy harvesting devices of FIGS. 1-3 and 6;

FIG. 10 is a plot of amplitude data collected from an energy harvesting device such as the energy harvesting devices of FIGS. 1-3 and 6;

FIG. 11 is a perspective view of yet another exemplary embodiment of an energy harvesting device;

FIG. 12 is a plot of rectifier output data collected from an energy harvesting device such as the energy harvesting devices of FIGS. 1-3, 6, and 11; and

FIG. 13 is a plot of capacitor charge data collected from an energy harvesting device such as the energy harvesting devices of FIGS. 1-3, 6, and 11.

### DETAILED DESCRIPTION

Broadly stated, embodiments of an energy harvesting device are discussed that are constructed to generate electrical power from moving fluids (e.g., air). One or more of these embodiments is configured to convert wind energy into mechanical energy (e.g., vibration), which is converted into electrical energy that can be stored, such as in a battery or other energy storage device (e.g., a capacitor). In one embodiment, the energy harvesting device comprises one or more flexible bodies or oscillator elements, which can be arranged in one example in an array. The oscillator elements are configured to vibrate or oscillate in response to the flow of the moving fluid such as air moving at low velocities, e.g., in the range of 2-3 m/s. This is beneficial because the energy harvesting devices of the present disclosure are effective in environments wherein the wind velocity is much less than, e.g., the wind velocity required to start-up and maintain operation of rotary turbine (e.g., windmills) and related technologies.

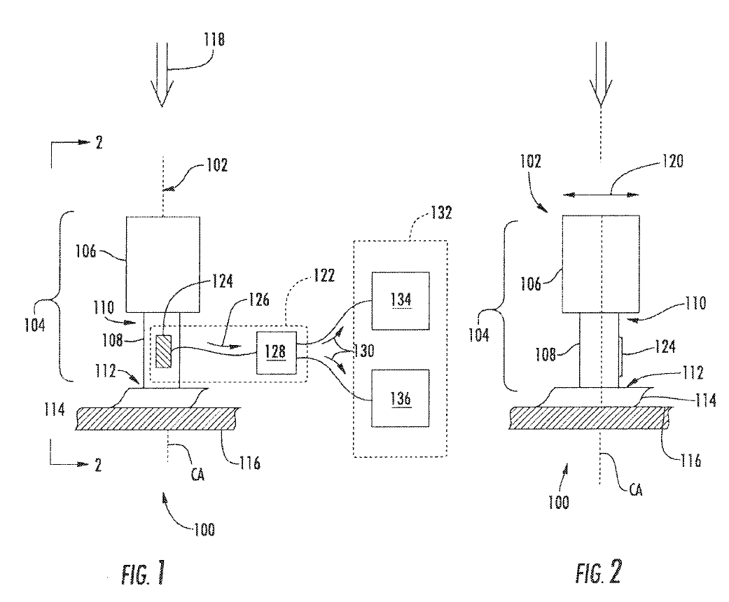

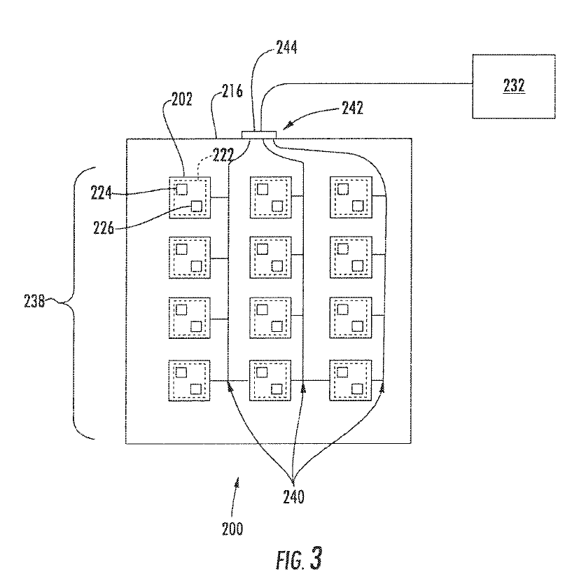

These concepts are discussed next with reference to FIGS. 1 and 2, in which there is depicted an exemplary embodiment of an energy harvesting device 100. The energy harvesting device 100 includes a vibrating or oscillator element 102 that includes a body 104 with a blunt-body portion 106 and a flexible structure 108 with a first end 110 to which the blunt-body portion 106 is secured. A second end 112 of the flexible structure 108 is coupled to a frame 114, which is configured to be secured or attached to a structure 116 (e.g., a part of a house) to expose the oscillator element 102 to a moving fluid 118. Exposure to the moving fluid 118 causes mechanical movement of the oscillator elements 102, as generally identified by the numeral 120. An energy converter 122 is provided, which in this example comprises a first converter device 124 that can be secured to the oscillator elements 102 such as on the flexible structure 108. The first converter device 124 is configured to convert the mechanical movement 120 into an input 126, which is coupled to a second converter device 128. The second converter device 128 is configured to modify the input 126, thereby generating an output 130, which is coupled to an external device 132 such as a load 134 and/or a storage device 136, e.g., a battery or a capacitor.

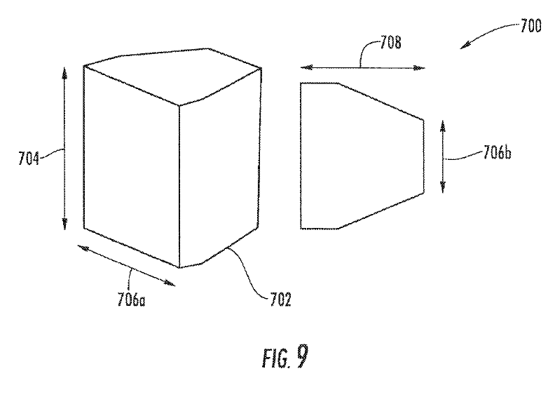

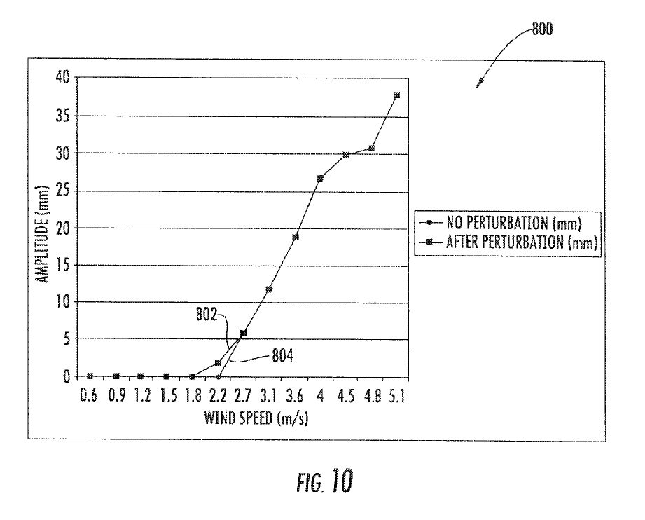

The inventors have identified certain characteristics of the oscillator elements 102 that facilitate implementation of the energy harvesting device 100 at low wind speeds. The blunt-body portion 106, for example, is selected to maximize the mechanical movement 120 such as by causing peak values for the amplitude of vibration of the oscillator elements 102. Various configurations are contemplated for the blunt-body portion 106 including cylinders (e.g., rectangular cylinders), cubes, and other three-dimensional shapes that are sensitive and that can cause the mechanical movement 120 at the low wind speeds. In one example, which is discussed below in the EXPERIMENTAL SECTION and illustrated in FIG. 9, the blunt-body portion 106 is a trapezoidal shape.

The flexible structure 108 is configured to work in conjunction with the blunt-body portion 106 to facilitate the mechanical movement 120 (e.g., vibration and/or oscillation) as well as to minimize hysteresis and other instabilities that can occur at low wind speeds. As illustrated in FIGS. 1 and 2, the flexible structure 108 can be arranged as a cantilever beam in which the second end 112 is affixed to, e.g., the frame 114. This arrangement limits the mechanical movement 120 to bending about a central axis (CA). Other configurations of the flexible structure 108 are contemplated, however, wherein the flexible structure 108 can twist, flex, or otherwise exhibit the mechanical movement 120 about a variety of axis (including the central axis (CA)) as well as about or in connection with other degrees-of-freedom that are provided by particular coupling of the second end 112 to the frame 114.

Materials for use in the pieces of the oscillator element 102, such as the blunt-body portion 106 and the flexible structure 108, are selected to permit and facilitate the mechanical movement 120 as contemplated herein. Metals (e.g., stainless steel), composites, and plastics can be useful in one or more of these pieces. The materials may also be compatible with and resilient to environmental conditions such as water (e.g., rain, snow, and ice), heat, cold, and the like. When constructed, the blunt-body portion 106 and the flexible structure 108 can be formed monolithically such as from a unitary piece of material that is shaped and configured to exhibit the characteristics of the oscillator element 102 discussed above. The pieces of the oscillator element 102 can also be constructed separately, such as in one or more pieces for each of the blunt-body portion 106 and the flexible structure 108. These pieces can be assembled together using techniques familiar to those artisans skilled in the relevant arts.

To convert the mechanical movement 120 to electrical energy, the first converter device 124 is coupled to the oscillator elements 102. The first converter device 124 may be constructed as part of the oscillator element 102 such as one or more layers of material that is incorporated as part of the flexible structure 108. Examples of the first converter device 124 can include, but are not limited to, piezoelectric elements, piezopolymer elements, electrostatic elements, electromagnetic elements, and other types of electro-mechanical transduction devices. In one example, the first converter device 124 can be secured to the flexible structure 108 to effectuate the conversion of the mechanism movement 120 to electrical energy such as would occur using piezoelectric elements. The inventors understand, however, that certain configurations of, e.g., the first converter device 124 and/or the oscillator element 102, may preclude certain configurations of the first converter device 124 and/or necessitate positioning of the first converter device 124 such as on the blunt-body portion 106.

Electrical energy from the first converter device 124 is conducted to the second converter device 128 as the input 126, which can be in the form of an alternating current (AC) input. The second converter device 128 can be configured to convert the AC input to a direct current (DC) output (e.g., the output 130). The DC output can be stored in the storage device 136 and/or distributed directly to the load 134. Although not shown in FIGS. 1 and 2, in one embodiment the AC input is provided directly to a device (not shown) which is compatible with the AC input and/or which can store, distribute, or otherwise utilize the AC input.

Turning next to FIG. 3, another exemplary embodiment of an energy harvesting device 200 is illustrated. Like numerals are used to identify like components as between FIGS. 1-3, except that the numerals are increased by 100 (e.g., 100 in FIGS. 1 and 2 is 200 in FIG. 3). For example, the energy harvesting device 200 comprises a plurality of oscillator elements 202 disposed on a frame 216. An energy converter 222 comprising a first converter device 224 and a second converter device 228 is provided, one each being coupled to the oscillator elements 202 and the latter, i.e., the second converter device 228, being coupled to an external device 232. Pertinent to the present example, it is shown that the oscillator elements 202 are arranged in an array 238 such as the four (4) by three (3) array that is illustrated in FIG. 3. An energy buss 240 is coupled to each of the oscillator elements 202 and to a central connection point 242 positioned on the frame 216. The central connection point 242 is configured such as with a connector 244 or other configuration to place in electrical connection the DC output and the external device 232.

Embodiments of the energy harvesting device 200 can include any number of the oscillator elements 202 as desired for efficient energy conversion at low wind speeds. This number can vary as between, in one embodiment, from a few as one or two, to dozens, and even to thousands of the oscillator elements 202. In such implementations, the oscillator elements 202 can be located in close proximity to one another, thereby affecting the operation (e.g., the mechanical movement 120) as between adjacent ones of the oscillator elements 202. In one example, the oscillator elements 202 within proximity to one another in the array 238 can exhibit mechanical movement 120 of the same or similar type, e.g., vibration at the same or similar phase.

Noted in the present example is that each of the oscillator elements 202 is constructed with the second converter device 228 located on or proximate the oscillator elements 202. Using certain construction technologies, such as solid-state, integrated circuit, or related semiconductor processes, it is contemplated that the second converter device 228 can be constructed to be positioned in this manner. In one example, the energy converter 222 including the first converter device 224 and the second converter device 228 are constructed as a single unitary element, such as would be consistent with an integrated circuit (IC) package. In another example, one or both of the first converter device 224 and the second converter device 228 are integrated into the construction of the oscillator element 202 such as part of the flexible structure 108 (FIGS. 1 and 2).

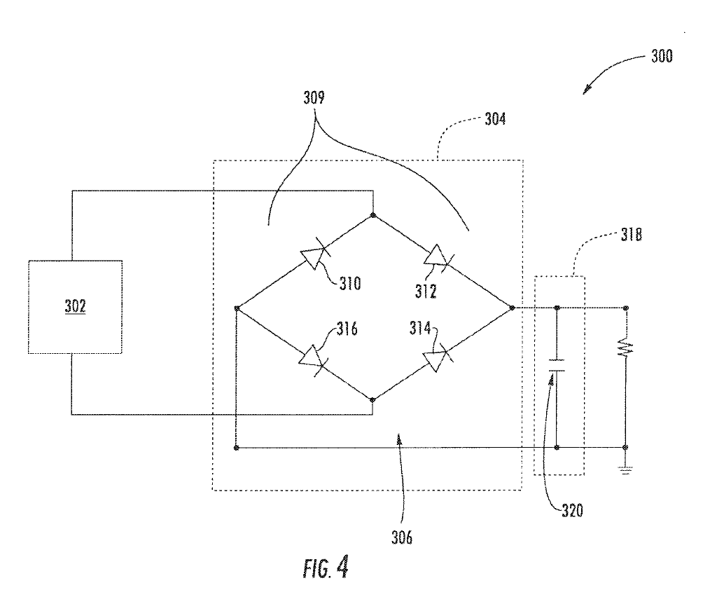

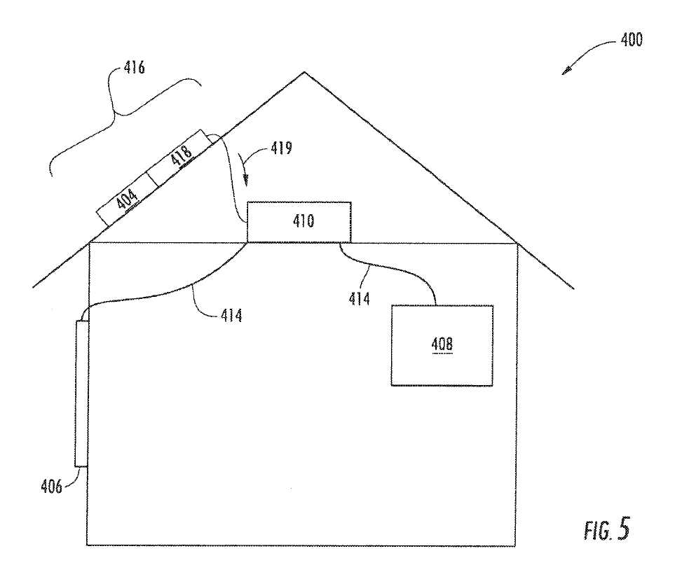

While a variety of configurations and devices can be used for the energy converter (e.g., the energy converter 122 and 222), there is illustrated in FIG. 4 an example of an energy converter 300 for use in an energy harvesting device such as the energy harvesting devices 100 (FIGS. 1 and 2) and 200 (FIG. 3). The energy converter 300 includes a first converter device 302 (e.g., the first converter device 124, 224) and a second converter device 304 (e.g., the second converter device 128, 228). The second converter device 304 comprises a rectifier circuit 306 such as a full bridge rectifier and/or full wave rectifier, which is one of many acceptable ways to rectify AC to DC as contemplated herein. By way of example, the rectifier circuit 306 comprises a diode bridge 308 in which there is found a first diode 310, a second diode 312, a third diode 314, and a fourth diode 316. A storage device 318 (e.g., the storage device 136, 236) is coupled to the rectifier circuit 306, which in this example is a capacitor 320.

As discussed above, the energy harvesting devices are configured to harvest energy that is found in, for example, air flow at low wind speeds. These devices can be secured to various portions of a house, office building, and related residential and commercial settings. When positioned on, e.g., the house, the oscillator elements are exposed to the environment, thereby positioning the oscillator elements in communication the various winds and air flows of the outside environment. The devices contemplated herein can be deployed to take advantage of these variety of wind types (e.g., turbulent and laminar flows) as well as velocities (e.g., high wind speeds and low wind speeds) so as to generate electrical energy for use and/or storage in the home.

In FIG. 5, there is depicted one implementation of an energy generating system 400 for a premise (e.g., a house, building, apartment, commercial building, residential building) that comprises one or more energy harvesting devices 402 (e.g., the energy harvesting devices 100, 200, and 300) including a first energy harvesting device 404, a second energy harvesting device 406, and a third energy harvesting device 408. The energy generating system 400 also includes an external device 410 (e.g., the external devices 132, 232, 332), in this case a storage device 412 that can receive and store an output 414 from each of the energy harvesting devices 402. In one embodiment, the first energy harvesting device 404 is part of a hybrid energy generating system 416 that includes a solar array 418, which can convert energy from sunlight into electricity such as by photovoltaic effect.

Some advantages of the concepts discussed above and as applied to one or more of the embodiments discuss herein include:

The use of aeroelastic instabilities between solid and flexible bodies to convert steady and unsteady wind energy into vibratory energy;

The use of electro-mechanical transduction to convert vibratory elastic vibration into stored electrical energy to be used at a later time;

The use of an array of closely packed elastic oscillator elements that exhibit aeroelastic vibratory instabilities at low wind velocities in the exemplary range of 2-3 m/s;

The use of an array of oscillators coupled to an electro-mechanical transduction system, which in one embodiment has the potential to produce between 10-50 W/m² for arrays with densities of oscillators between 200 and 1000 oscillators/m²;

The use of solid piezoelectric, piezopolymer, and electro-magnetic transduction means of converting elastic vibratory energy into stored energy in an electric capacitor;

The use of full wave sold state rectifiers for each oscillator to convert oscillating electrical signals from an array of oscillator elements into stored electrical energy independent of the phase of the oscillators and independent of the transient nature of the fluid (e.g., air) flow;

The use of a trapezoidal shape having parameters selected to produce an aeroelastic instability at the lowest wind velocity without hysteresis in a vibration amplitude-wind velocity relation;

The implementation of such energy harvesting devices with the potential to convert wind energy twenty-four (24) hours a day, in comparison with solar panel technology; and

The combination of such energy harvesting devices with other alternative energy sources (e.g., solar panel technology) to provide a hybrid wind-solar panel system.

### EXPERIMENTAL SECTION

The foregoing discussion presented embodiments of devices that are configured to harvest energy from moving fluids, and in one or more particular embodiments, the devices are configured to transform energy from air flow such as wind at low velocity (e.g., 2-3 m/s) to electrical energy. This EXPERIMENTAL SECTION provides additional examples and/or implementations of the concepts disclosed herein. The discussion is broken into two parts, which include (1) Theory of Vibro-Wind Technology; and (2) Experimental Results.

### 1. Theory of Vibro-Wind Technology

The term “vibro-wind” denotes technology directed to the harvesting of energy from the wind as it flows around vibrating structures as an alternative to conventional wind-driven devices, e.g., rotary wind turbines. This technology is useful to capture energy from wind as it flows around commercial and residential buildings and to supplement or act as an alternative energy source to solar energy devices. That is, whereas solar energy devices are relatively effective during only the “daytime” or sunlight hours, devices that deploy vibro-wind technology can continue to generate electrical energy for almost twenty-four (24) hours a day. In addition to night-time generation of power, vibro-wind technology can be effective in wind velocity environments as low as 2-3 m/s, which is below typical rotary turbine start-up velocities that require wind velocity at or around 9-10 m/s.

There is a great interest in architectural building design in “building integrated power generation” or BIPG. In order for vibro-wind technology to be successful, the design concept of putting vibrating structures on building facades must be acceptable to the professional architecture community. Fortunately there is precedent for dynamic elements in architecture originating in the kinetic sculpture or kinetic art world. As early as the 1970's the sculptor Harry Bertoia was using hundreds of vibrating rods of 1-2 meters in length in architectural environments to produce musical sounds in the flow of wind around buildings (See e.g., Nelson, 1970). In the 1990's the Japanese kinetic sculptor, Susumu Shingu, had installed large oscillating wind vanes on roofs, towers, and domes that vibrated in the wind. One of these sculptures can be seen at an outdoor underground station in Cambridge, Mass. (See, Shingu, 1997). More recently, the kinetic artist and designer Ned Kahn has designed panels ranging in size to 80 feet by 450 feet with 80,000 vibrating plates for architectural projects in Charlotte N.C. and Winterthur, Switzerland. These thousands of small vibrating plates are designed to produce visual wave-like effects as the wind blows around the buildings (See Streitfeld, 2008).

The basic science involves energy extraction from bodies induced to vibrate due to the nonlinear action of fluid flow and vortices around flexible structures. However, two problems with vibro-wind technology are (i) how to convert wind energy into vibratory mechanical energy; and (ii) how to maximize mechanical energy conversion into electrical energy and storage from the vibration of an array of oscillator elements (e.g., the oscillator elements 102, 202 discussed above). In one implementation, the wind is used to excite dozens up to thousands of small vibrating elements on panels attached to a structure (see, e.g., FIGS. 3 and 5), converting the kinetic energy into electrical energy that can be used in the operation of, e.g., electrical appliances and devices in the building.

There are two steps in the conversion process. One step is to convert the wind energy into vibration. Another step is to convert the vibration, or mechanical vibratory kinetic energy, into electrical energy. Successful adaptation of each of these steps, however, can generate power output comparable to solar panels and may be used, as mentioned above, to complement solar panel systems during the night-time or serve as an alternative to solar panels for building applications such as in urban areas.

Consider, for example, that the flow of wind power P (W/m²) past an area (A) normal to the flow velocity (V) is proportional to the density of air (r) as given by Equation 1 below:

$$P = \frac{{rV}^{3} A}{2} . \qquad Equation 1$$

With the density of air, ‘r’, of about 1.2 kg/m³, the power density P of wind at V=10 m/s is about P=600 W/m². This power density is effectively the same for rotary wind turbine systems and vibro-wind systems. Considering that it is unlikely to capture all of this energy, it may be possible to convert upwards of 30% of the available power into structural vibration energy, thereby resulting in a power density of P=180 W/m². If in one example one were to scavenge 30% of the available structural vibration energy into electrical energy, the power density would be about P=54 W/m².

Commercial solar photo-voltaic panels have an area power density of around P=60-110 W/m². So the power output of vibro-wind technology is comparable to solar photo-voltaic technology. Moreover, although the power output (P) of vibro-wind technology may be on the low end of the power output (P) of solar photo-voltaic technology, an integrated system of these two technologies could generate energy comparable to or greater than solar because wind is typically available 24 hours on a daily basis.

Several modes of excitation are recognized in vibro-wind technology:
1. Galloping vibrations (Den Hartog 1932; Parkinson & Smith 1964)
2. Vortex-induced resonance or von Karmen vortex shedding (Blevins 1978)
3. Bimodal flutter instability
4. Wind transient vibrations
5. Membrane wave-like vibrations.

For very low velocities the fluid will move around an obstacle in a steady state pattern. However, for larger velocities or Reynolds number (Re) the flow becomes unsteady and alternative vortex patterns move behind the obstacle and that, in turn, generates non-steady pressure forces. If the obstacle is constrained by a flexible structure, vibratory motions will occur from which we can then generate electric energy. However, there are also effective negative damping dynamics of wind interacting with blunt bodies, called galloping, that do not depend on vortex resonance.

In the vortex shedding model there are two non-dimensional parameters: the Reynolds number (Rd), which is proportional to the fluid velocity, and the Strouhal number (S), which characterizes the vortex frequency as set forth in Equation 2 below:

$$S = \frac{fD}{U} , \qquad Equation 2$$

where f is the frequency of vortex shedding, D is the characteristic length, and U is the velocity of the fluid.

For obstacles of the order of D=50 mm, and velocities on the order of U=10 m/s, the Reynolds (Re) is around 30,000. In this regime, the alternating vortex flow behind a cylinder-type obstacle is well established with a given frequency. It can be shown in this regime, for example, that for 102<Re<105, S=0.15, and f is the shedding frequency in cycles per second, then for an obstacle or flat plate of width D=50 mm and U=5 m/s, f=15 Hz. Moreover, if the shedding frequency is in resonance with the frequency of the oscillator element (e.g., the oscillator element 102, 202 above), a vibration amplitude on the order of 0.2D is possible due to vortex shedding forces. For structural natural frequencies below the vortex shedding frequency, galloping vibrations can generate another self-excitation mechanism for structural oscillations.

Blunt-shaped bodies (e.g., the blunt-body portion 106), such as cylinders with square cross-sections, are most sensitive to vortex-induced wind forces as well as galloping wind forces. Also sharp-edge structures, such as can be observed in so called ‘stop-sign’ flutter, are susceptible to wind induced vibrations. In vibro-wind devices, the design goal is to choose the most un-aerodynamic shape, which is in sharp contrast to applications in, e.g., aircraft fluid dynamics design.

Calculations can be made to estimate the available kinetic energy for an array of oscillator elements with blunt-shaped bodies. Each oscillator element contributes to the energy transfer from the wind to structural kinetic energy. In one example, assuming a vibrating mass (m) for one elastic structure of frequency (f) and a sinusoidal oscillation of amplitude Δ, the kinetic energy of the oscillator element is given by Equation 3 below:

T=2π²mf²Δ² cos²(2πft), Equation 3

If this energy were absorbed in one cycle, a figure of merit of oscillator power availability is given by Equation 4 below:

P_{elastic}=2π²mΔ²f, Equation 4

If there were N oscillator elements per square meter, then the power available is given by Equation 5 below:

P=NP_{elastic}, Equation 5

For a mass of about 18 grams per oscillator, 100 oscillators per square meter (e.g., one oscillator in a 10 cm×10 cm area), and wherein each have a natural frequency of about 30 Hz, and wherein Δ=1, the power density is about P=100 W/m². These vibration parameters are possible in fluid flow at a velocity of around 10 m/s. Thus, the power density for an array of oscillator elements is on the same order when compared to the power density of solar photo-voltaic technology (of P=60-110 W/m²).

### 2. Experimental Results

For further clarification, instruction, and description of the concepts above, embodiments of the present disclosure are now illustrated and discussed in connection with the following examples. Note that any dimensions provided in connection with any examples are exemplary only and should not be used to limit any of the embodiments or concepts of the present disclosure, as it is contemplated that actual dimensions will vary depending on the practice and implementation of the concepts discussed herein as well as a variety of factors, many of which are presented in the discussion above.

### Example I

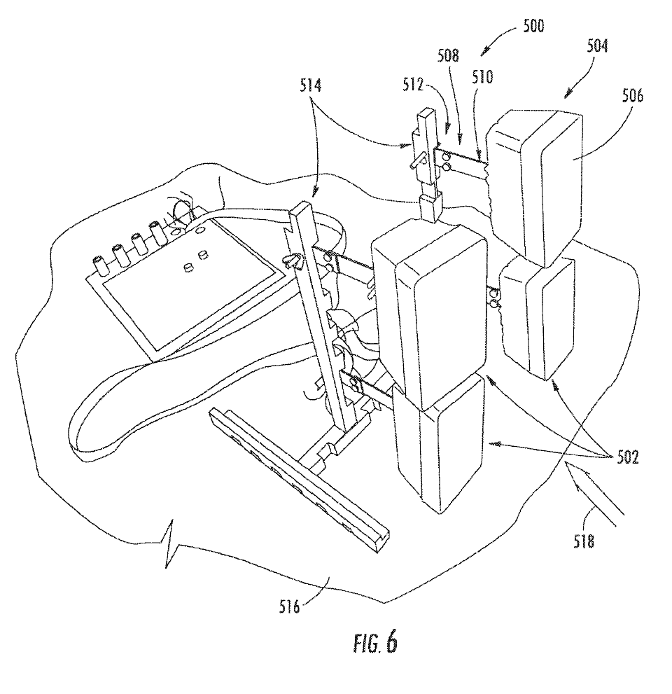

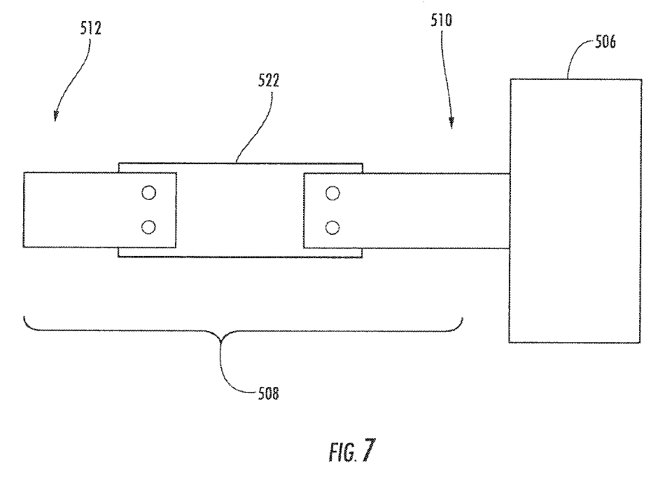

With reference now to FIGS. 6-9, an exemplary embodiment of an energy harvesting device 500 (FIG. 6) is illustrated. The energy harvesting device 500 includes a plurality of oscillator elements 502 that includes a body 504 with a blunt-body portion 506 and a flexible structure 508 with a first end 510 to which the blunt-body portion 506 is secured. A second end 512 of the flexible structure 508 is coupled to a frame 514, which is configured on a structure 516 (e.g., a table top) to expose the oscillator elements 502 to a moving fluid 518. The frame 514 may be constructed in the form of an integrated device, or a power panel, in which can be secured to the structure 516 and which is configured for transport and delivery such as from a factory or manufacturing facility to a premise (e.g., a home).

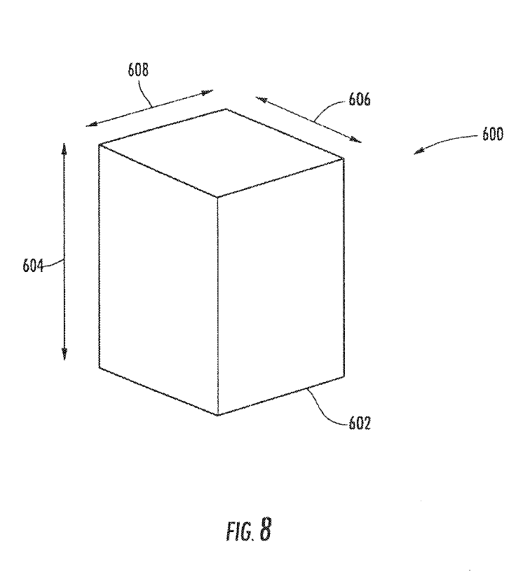

In one example, and as best depicted in FIG. 7, each of the bodies 504 has a composite structure that comprises a first converter device 522 such as a piezo system, which is used to couple the first end 510 to the second end 512. The four composite structures have a minimum frequency of 7 Hz. The composite beams generate a maximum voltage of 62±3 Volts under a winds speed of 5.2 m/s. The length of the bodies 504 is about 125 mm, with the first end 510 has a thickness of about 0.1 mm and a length of about 6 mm. The second end 512 has a thickness of about 0.25 mm and a length of about 19 mm. Each of the first end 510 and the second end 512 is constructed of steel as used in standard feeler gauges.

With reference to FIGS. 8 and 9, data was collected for a variety of configurations for the blunt-body portion 506. In one example, illustrated in FIG. 8, a blunt-body portion 600 is constructed as a rectangular cylinder 602, which has a height parameter 604 (H), a width parameter 606 (W1), and a depth parameter 608 (D). Another example of a blunt-body portion 700 is illustrated in FIG. 9. The blunt-body portion 700 is constructed as a trapezoid cylinder 702, which has a height parameter 704 (H), a first width parameter 706A (W1), a second width parameter 706B (W2), and a depth parameter 708 (D).

The energy harvesting device 500 was tested in a wind tunnel with a cross-sectional area of about 254 mm×254 mm. Table 1 below summarizes the data collected for the configurations of the blunt-body portion 600 and 700 as implemented on the energy harvesting device 500 (FIG. 6).

TABLE 1

| | | | | | | | | Fre- |
|---|---|---|---|---|---|---|---|---|
| | Wind | | | | | | Max | quen- |
| | Speed | Mass | H | W1 | W2 | D | Voltage | cy |
| Shape | (m/s) | (g) | (mm) | (mm) | (mm) | (mm) | (V) | (Hz) |
| Rectangle | 4.5 | 5 | 76 | 50 | — | 50 | 29.5 | 5.51 |
| Rectangle | 4.5 | 4.3 | 76 | 50 | — | 44 | 32 | 7.84 |
| Trapezoid | 4.5 | 4.1 | 76 | 50 | 25 | 50 | 50 | 6.3 |
| Trapezoid | 4.5 | 3.9 | 76 | 50 | 12 | 50 | 51 | 6.3 |

In one embodiment, the blunt-body portion has the following parameters, as summarized in Table 2 below.

TABLE 2

| | Mass | H | W1 | W2 | D |
|---|---|---|---|---|---|
| Shape | (g) | (mm) | (mm) | (mm) | (mm) |
| Trapezoid | 4.1 | 76 | 50 | 25 | 44 |

### Example II

Using an energy harvesting device similar to the energy harvesting device 500 (of FIG. 6), data was collected for an oscillator element (e.g., the oscillator elements 502) have properties as outlined in Tables 3 and 4 below.

TABLE 3
Flexible Structure

| | |
|---|---|
| First End | Second End |

| Thickness | Length | Thickness | Length |
|---|---|---|---|
| (mm) | (mm) | (mm) | (mm) |
| 0.1 | 6 | 0.25 | 19 |

TABLE 4
Blunt-Body Portion

| | |
|---|---|
| First End | Second End |

| Thickness | Length | Thickness | Length |
|---|---|---|---|
| (mm) | (mm) | (mm) | (mm) |
| 0.1 | 6 | 0.25 | 19 |

In one implementation, the oscillator element was tested to identify the relationship between the amplitude and wind speed. The wind speed was varied from 0 m/s to 5.1 m/s. The data collected is summarized in Table 5 below.

TABLE 5

| Wind | No | Max | After | Max |
|---|---|---|---|---|
| Speed | Perturbation | Voltage | Perturbation | Voltage |
| (m/s) | (mm) | (V) | (mm) | (V) |
| 0.6 | 0 | 0 | 0 | 0 |
| 0.9 | 0 | 0 | 0 | 0 |
| 1.2 | 0 | 0.5 | 0 | 0.5 |
| 1.5 | 0 | 0.5 | 0 | 0.5 |
| 1.8 | 0 | 1 | 0 | 1 |
| 2.2 | 0 | 1 | 2 | 5 |
| 2.7 | 6 | 9.2 | 6 | 9.2 |
| 3.1 | 12 | 19 | 12 | 19 |
| 3.6 | 19 | 30 | 19 | 30 |
| 4 | 27 | 47.5 | 27 | 47.5 |
| 4.5 | 30 | 54 | 30 | 54 |
| 4.8 | 31 | 57.5 | 31 | 57.5 |
| 5.1 | 38 | 60 | 38 | 60 |

The data of Table 5 indicates that the oscillator element required low wind speed (a minimum of 2.7 m/s) to start the oscillation, thus electricity could be collected even at low wind speeds.

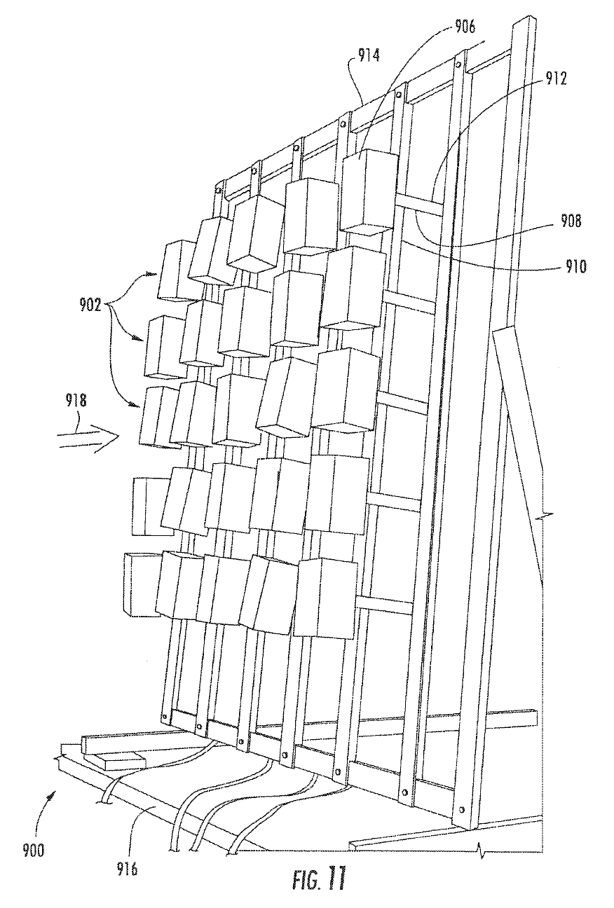

Moreover, and turning now to FIG. 10, the data of Table 5 is shown in the plot 800, which is a plot of the Amplitude (mm) vs. Wind Speed (m/s). In this example, the oscillation of the oscillator element under normal operation conditions (i.e., No Perturbation) is identified on the plot as item 802. The oscillation of the oscillator element when a force is applied (i.e., After Perturbation) is identified on the plot as item 804.

With reference to plot 800, it is noted that the galloping mode oscillator is a non-linear limit cycle instability that often exhibits a hysteretic behavior in a “vibration amplitude-wind speed” relation. However, in one embodiment, the oscillator element having the characteristics of the flexible structure and the blunt-body portion (as identified in the Tables 3 and 4) effectively eliminated the hysteresis in the vibration amplitude-wind speed relation, as shown by the close relationship between the items 802 and 804 on the plot 800.

The reduction in the hysteresis can be discussed in connection with one or more critical wind speeds, which identify the wind speed(s) at with the oscillator goes unstable and begins to vibrate. In one embodiment, the difference between the critical speeds such as between the critical winds speeds of the perturbation (item 802) and no perturbation (item 804) is less than 25%, and in one particular construction the difference is from about 5% to about 15%. This provides a robust design in which the oscillator elements can vibrate and generate electricity at lower wind speeds. With reference to the plot 800 of FIG. 10, the critical wind speed on item 802 is about 1.8 m/s. The critical wind speed on item 804 is about 2.2 m/s.

### Example III

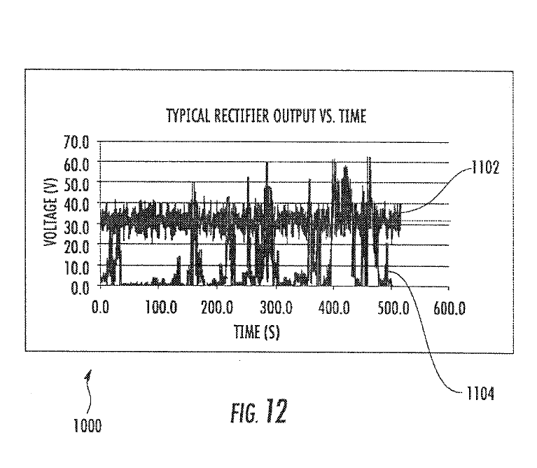

With reference now to FIGS. 11-13, another exemplary embodiment of an energy harvesting device 900 (FIG. 11) is illustrated. The energy harvesting device 900 includes a plurality of oscillator elements 902 that includes a body 904 with a blunt-body portion 906 and a flexible structure 908 with a first end 910 to which the blunt-body portion 906 is secured. A second end 912 of the flexible structure 908 is coupled to a frame 914, which is configured on a structure 916 (e.g., a floor) to expose the oscillator elements 902 to a moving fluid 918.

The present example is provided to illustrate scalability of the concepts disclosed herein. Earlier experimental data was collected in connection with a 2×2 array of the oscillator elements (e.g., the oscillator elements 502). Comparatively, the energy harvesting device 900 comprises twenty-five (25) of the oscillator elements 902, which are arranged in a 5×5 array.

The blunt-body portion 906 of each of the oscillator elements 902 is constructed of Styrofoam® in the form of a square cylinder with dimensions of 2 cm×2 cm 6 cm. Each cylinder is coupled to a steel cantilevered feeler gauge, which embodies the flexible structure 908 in the present example. In one embodiment, the oscillator elements 902 have a natural frequency of about 8-10 Hz.

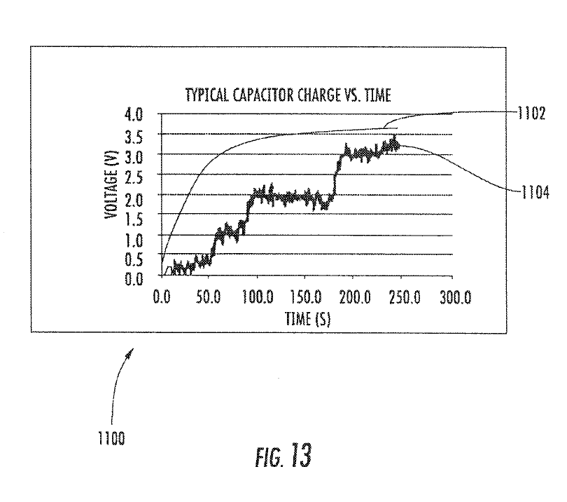

Data was collected for the 5×5 array when subject to air flow in a wind tunnel and in an outdoor environment. Wind speeds ranged up to about 6-8 m/s. There is illustrated in FIG. 12 a plot 1000 of the rectifier output over time, in which the voltage generated by the array subject to variation in the wind velocity for the outdoor experiments (identified by item 1002) is compared to the voltage generated by the array subject to steady wind velocity in the wind tunnel (identified by item 1004). In FIG. 13, a plot 1100 is provided of the capacitor charge over time, in which the energy stored by the array subject to variation in the wind velocity for the outdoor experiments (identified by the item 1102) is compared to the voltage generated by the array subject to steady wind velocity in the wind tunnel (identified by item 1104).

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

While the present disclosure has been particularly shown and described with reference to certain exemplary embodiments, it will be understood by one skilled in the art that various changes in detail may be effected therein without departing from the spirit and scope of the disclosure as defined by claims that can be supported by the written description and drawings. Further, where exemplary embodiments are described with reference to a certain number of elements it will be understood that the exemplary embodiments can be practiced utilizing either less than or more than the certain number of elements.

What is claimed is:

1. An energy harvesting device, comprising:
an oscillator element; and
an energy converter coupled to the oscillator element and configured to generate electricity in response to movement of the oscillator element,
wherein the difference between a critical wind speed for the oscillator element with a perturbation and a critical wind speed for the oscillator element without a perturbation is less than about 25%.

2. An energy harvesting device according to claim 1, wherein the oscillator element comprises a blunt-body portion and a flexible structure with a first end on which the blunt-body portion is secured and a second end affixed in position.

3. An energy harvesting device according to claim 2, wherein the oscillator element is configured to vibrate in response to a moving fluid with a velocity of about 3 m/s.

4. An energy harvesting device according to claim 2, wherein the energy converter is integrated into the oscillator element.

5. An energy harvesting device according to claim 1, wherein the energy converter comprises a piezoelectric element.

6. An energy harvesting device according to claim 1, wherein the energy converter is configured to generate electricity by electro-mechanical transduction.

7. An energy harvesting device according to claim 1, wherein the energy converter comprises a piezopolymer.

8. An energy harvesting device according to claim 1, wherein the energy converter comprises an electrostatic element.

9. An energy harvesting device according to claim 1, wherein the oscillator element comprises a blunt-body portion in the form of a trapezoid.

10. An energy harvesting device according to claim 1, wherein the oscillator element comprises a flexible structure with a first end and a second end coupled to the first end by a piezoelectric element.

11. A power panel, comprising:
a frame;
an array of vibrating elements secured to the frame; and
an energy converter responsive to vibration of the array of vibrating elements,
wherein the difference between a critical wind speed for one or more of the vibrating elements with a perturbation and a critical wind speed for one or more of the vibrating elements without a perturbation is less than about 25%.

12. A power panel according to claim 11, wherein the energy converter comprises a first converter device that is configured to convert mechanical vibratory motion of the vibrating elements to an input.

13. A power panel according to claim 12, wherein the energy converter comprises a second converter device that is configured to convert the input to an output, and wherein the output is alternating current.

14. A power panel according to claim 13, wherein each of the first converter device and the second converter device are coupled to the vibrating elements.

15. A power panel according to claim 13, wherein the second converter device comprises a full bridge rectifier.

16. A system, comprising:
an energy harvesting device;
an energy converter coupled to the energy harvesting device, the energy converter comprising a first converter device that is configured to convert mechanical vibratory motion into electrical energy; and
an external device coupled to the energy converter, the external device comprising one or more of a storage device and a load,
wherein the energy harvesting device has an oscillator element that is configured to vibrate in response to a moving fluid, and
wherein the difference between a critical wind speed for the oscillator element with a perturbation and a critical wind speed for the oscillator element without a perturbation is less than about 25%.

17. A system according to claim 16, further comprising a solar photovoltaic coupled to the external device.

18. A system according to claim 17, wherein the solar photovoltaic is incorporated into the energy harvesting device.

19. A system according to claim 16, wherein the oscillator element comprises a blunt-body portion with a trapezoidal shape.

20. A system according to claim 16, wherein the storage device is one or more of a capacitor and a battery.
